(19) United States
(12) Patent Application Publication
(10) Pub. No.: US 2008/0310765 A1
(43) Pub. Date: Dec. 18, 2008

(54) Optoelectric sensor and method for the detection of codes

(75) Inventors: Jurgen Reichenbach, Emmendingen (DE); Uwe Schopflin, Niederwinden (DE)

Correspondence Address: THE NATH LAW GROUP, 112 South West Street, Alexandria, VA, 22314, US

(73) Assignee: SICK AG, Waldkirch (DE)

(21) Appl. No.: 12/155,987

(22) Filed: Jun. 12, 2008

(30) Foreign Application Priority Data
Jun. 14, 2007 (EP) 07 110 258.6

(51) Int. Cl. G06K 7/00

(52) U.S. Cl. 382/312

(57) ABSTRACT

An optoelectronic sensor (10) for the detection of codes having a light receiver (22) is set forth which is designed for reading in segments of color image data or gray value image data as well as having an evaluation unit (30) which can assemble the image data to form a total image (100), wherein a binarizer (26) of the sensor (10) is additionally provided to generate a binary image (102) from the color image data or gray value image data.

In this connection, the binarizer (26) is designed for a conversion into the binary image (102) during the reception and/or in real time in that the color image data or gray value image data of each read in segment are binarized while the further segments are still being read in.

A corresponding method for the detection of codes is furthermore set forth.

The invention relates to an optoelectronic sensor and to a method for the detection of codes in accordance with the preambles of claims 1 and 3 and 17 and 19 respectively.

Code readers which scan the code line-wise using a light ray represent a possibility of optically detecting one-dimensional bar codes or two-dimensional matrix codes. Code readers based on a camera chip are in particular used with the matrix codes. This camera can also be only a camera line and the image is assembled, whereas a mobile code reader is moved over the object to be read or the objects with the codes to be detected are led past a stationary code reader. A frequent application is the automatic sorting of parcels in logistics centers or of pieces of baggage at airports.

As a rule, such cameras deliver a gray value image or a color image, for example an RGB image with three color channels. These image data are digitized via an A/D converter. With a number of industrial image processing applications, and also with code reading, the major information is already contained in the brightness differences of a gray value image. A gray value resolution or color depth of 8 bits, which corresponds to 256 colors or gray image scales, is already sufficient for most applications.

A binary image, that is a purely black and white image with a resolution of only one big per pixel, results in a substantial data reduction for the internal further processing and for the transmission from the code reader to external. More data per time unit can thus be transmitted or a lower bandwidth can be used. On the other hand, there is, however, the risk of losing major information by the reduction from, for example eight bits, to one bit per pixel. To prevent this, more complex binarization algorithms have to be used which, however, in turn require a relatively high computing time.

In the final analysis, the user of a code reader or the connected controller is not necessary interested in the actual image data. Instead, frequently only the recognized texts and the decoding results should be output and an association with the associated object should be possible, for instance to be able to convey it in the correct direction on a conveyor belt for sorting. It is sufficient for this purpose to limit oneself to so-called regions of interest (ROIs) which correspond to objects, texts or codes. Even within these regions of interest, the actual relevant information is the decoded clear text and not the image information. However, a code reader which only outputs these decoded data is difficult to monitor with respect to the correctness of its results.

It is therefore the object of the invention to provide an optical sensor for the detection of codes which extracts the relevant information reliably and efficiently. In a further embodiment of the invention, the object is to make the way in which this information was derived transparent and monitorable for the user or for the connected controller and/or to give this controller the possibility to carry out further image evaluations which is simplified by preprocessing.

This object is satisfied by a sensor in accordance with claim 1 and by a method in accordance with claim 12. The binarization by which the data volume is substantially reduced and the further evaluation is accelerated, does not delay the image processing in any way in accordance with the invention because it is carried out directly during the reception, substantially in real time. While the data which are required for the assembly of a total image of the code are therefore still running in, the respective already received data are already being binarized. A data reduction therefore takes place close to the process in the sensor without time delay. No high data flow therefore has to be transmitted to the external computer. If the color image or the gray image of a code has been fully read in, the binary image is also already available. Without the solution in accordance with the invention, a decoding based on the binary image would have to be carried out on the total image in a separate, delaying step.

The invention is thus based on the basic idea of carrying out preprocessing steps before the actual decoding in a kind of pipeline process. In accordance with the same idea, noise suppression filters or filters to compensate optical distortion can be included in this pipeline so that the fully preprocessed binarized image is directly present at that time at which the total image region is read in with the code.

In an advantageous further development of the invention for diagnosis, for monitoring the correct decoding of the sensor or for a furthergoing evaluation by a user or by an external controller, the evaluation unit is designed to generate a structured file which contains decoding results and/or overlay data with positions of regions of interest of recognized objects or of regions with codes or text. A known format for such a structured file is the XML format. All the relevant information of the detected objects and codes are thus contained in the structured file. The decoding results can be used for the actual application and for the sorting. The decoding can thus be checked or, for example, reproduced or extended using an alternative evaluation method. A corresponding solution of the furthergoing object is also set forth in claim 3.

The evaluation unit is preferably designed to output the total image, the binary image and/or a miniature image (thumbnail), in particular as a component of the structured file. It becomes understandable visually or for an external image evaluation by means of this image data how the sensor arrives at the decoding results and whether they are correct. In addition, supplementary evaluations can be carried out, for instance an OCR with comparison with an address database whose capacity and access possibilities are not available to the sensor itself. By means of “video decoding”, that is precisely by means of this image recording and presentation of the same to operating personnel, an error can also be localized or a manual intervention can be carried out subsequently to avoid or compensate the error directly. It is in each case a question of the application and configuration which of the three classes of image should are transmitted and which are not. The thumbnails serve for a less storage-intensive archiving and can be made available relatively easily everywhere via the internet or a similar network. The required storage capacities and bandwidths for the complete image data would not be present or would at least be cost-intensive.

The evaluation unit is advantageously designed to provide the structured file with cropping information which designates the position of objects in the image data, in particular with reference to positions of the corner points. This kind of cropping, that is the trimming of the image on a software basis, admittedly does not reduce the data volume to be transmitted. Later image evaluations outside the sensor can, however, carry out a cropping immediately and without any special computing effort with reference to the cropping information or can ignore the image data disposed outside the cropping region for an accelerated evaluation.

In this connection, the evaluation unit is furthermore preferably designed to provide the structured file with graphic instructions which mark the regions of interest visually on display of the structured file on an external display unit, in particular by colored rectangles and/or display the decoding results in text form. It is thus recognizable at a glance for the user whether all the codes are detected, whether they are associated with the correct object and whether they are plausibly decoded. It can also be understood and monitored with reference to the clear text whether, for example, the sorting is carried out in the correct manner. The configuration and checking of a system based on the optoelectronic sensor in accordance with the invention is thus substantially facilitated.

The evaluation unit is even more preferably designed to provide the structured file with information which make a connection between recognized objects, codes and/or decoding results. Reading errors are thus also avoided which are based on an association of a code, which is correctly decoded per se, with the false object or they are at least made visible for operating personnel that can then intervene to make corrections.

The evaluation unit is preferably designed to provide the structured file with information which describes the length, the width, the height and the maximum box volume of recognized objects and/or three-dimensional positions, in particular heights, of the recognized objects underlying regions of interest and/or regions with codes or text. This is important information for the sorting or the capacity planning. The position of the codes can help downstream external evaluations to locate further regions of interest. If, for instance, the sensor itself only reads one-dimensional and two-dimensional codes, but not text regions, an external OCR evaluation can search for text regions with the hypothesis almost always correct in practice that they are disposed in the vicinity of the codes. In this manner, a substantial part of the search effort can be avoided, for instance, in the external text recognition.

The sensor is advantageously a camera-based code reader, in particular having a line scan camera and/or mounted in a stationary manner at a conveyor. Although a scanner can generally also detect the image data line-wise or segment-wise, a camera is the mechanically less error-prone and the more reliable solution for an actual image processing. It is equally admittedly generally feasible to read in any desired geometrical image segments and to assemble them to the total image; however, a line-wise reading produces the least problems in the assembly of the individual segments. It is nevertheless easily feasible, for example, to use a multi-line matrix chip and only to use one active line or to read in respectively wider rectangles. Finally, the invention can also be combined with mobile sensors or code readers, but the main area of application is the sorting in logistics centers or analogue tasks at airports, for instance, described in the introduction. With these stationary applications, the conveying speed is constant or can at least be determined relatively easily and the assembly to form a total image is thereby facilitated and the decoding result is particularly reliable.

The binarizer is preferably designed for a binarization with floating and/or local binarization thresholds. A binarizer with a constant evaluation threshold would not always deliver a black and white image required for reliable decoding with the never completely constant illumination and shadow formations by uneven surfaces. This can be compensated by smart binarization algorithms.

The light receiver and the binarizer are advantageously designed to transmit the color image data or gray value image data of each segment to the evaluation unit substantially simultaneously with the binarized image date or to buffer them, in particular with the same relative addresses. The evaluation unit thus has direct access, or particularly fast access via the store to respective corresponding binary image data or, where the complexity of the decoding requires, color image data or gray value image data. In particular the same relative address facilitates the repeated later access to image data corresponding to one another.

In an advantageous further development of the invention, the light receiver is connected via at least one programmable logic component to the evaluation unit, in particular by PCI bus, and the binarizer and/or an image processing filter is implemented on the programmable logic component. This architecture enables a pipelining in which the programmable logic components each subject the incoming data to a corresponding preprocessing in real time in each case or almost in real time. In this connection, noise suppressing filters, brightness filters or filters for the correction of imaging errors of the optical system connected before the image sensor can be considered as the filter.

Again in an advantageous further development, the evaluation unit is integrated into a common housing with the sensor components and an interface is provided to transmit image data of the total image and of the binary image to external, in particular a wired serial or Ethernet interface or a wireless Bluetooth or WLAN interface. The sensor in the common housing thus represents a functional unit which is closed per se and which can carry out all relevant image processing. Finished decoding results are applied at the interface which can be used directly for sorting. An external computer for the image processing is no longer needed. If required, for instance for diagnosis purposes, however, further data, up to the complete image data, can also be output to external. With stationary applications, the wiring for a wired interface is often not particularly disturbing. If necessary, however, a wireless transmission can also be selected which makes disturbing cables superfluous in a portable unit or in a stationary application with tighter space conditions.

The binarizer and/or the evaluation unit is advantageously designed to compress the binary image in a loss-free manner or to encode it into the total image. A possible format for a loss-free compression is the run length encoding in which instead of a sequence of equivalent bits, rather therefore the number of these bits is stored as a numerical figure. This not only reduces the data, but also permits a faster examination of the binary image data for relevant code data. The binary image of one of the bits of the color information or gray value information can be completely without the necessary of additional storage requirement or bandwidth requirement. A bit will preferably be selected for this purpose which falsifies the color values or gray values as little as possible, for example the least significant bit (LSB).

In this connection, the evaluation unit is preferably designed to locate codes in the binary image with reference to characteristic search patterns, that is signatures, which identify a code as such with respect to other picture elements. This is a particularly fast and efficient manner to locate the relevant sites having code information in the image. In this connection, it is particularly advantageous that these search patterns are not only maintained in binary data compressed by run length encoding, but can actually even be located faster.

The method in accordance with the invention can be designed in a similar manner by further features and shows similar advantages. Such further features are described in exemplary, but not exclusive, form in the dependent claims following the apparatus claim.

The invention will also be explained in the following with respect to further advantages and features with reference to the enclosed drawing and to embodiments. The Figures of the drawing show in:

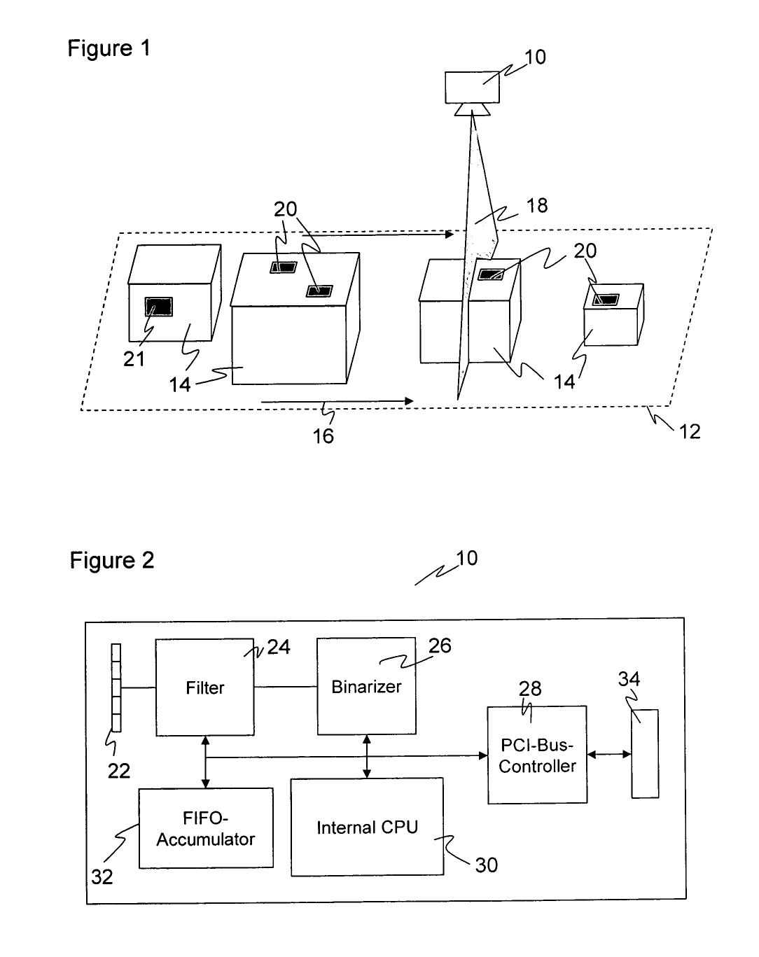

FIG. 1 a schematic, three-dimensional overview representation of the mounting of the optoelectronic sensor in accordance with the invention above a conveyor belt which conveys objects with codes to be read through the field of view of the sensor;

FIG. 2 a block diagram of an embodiment of the optoelectronic sensor in accordance with the invention;

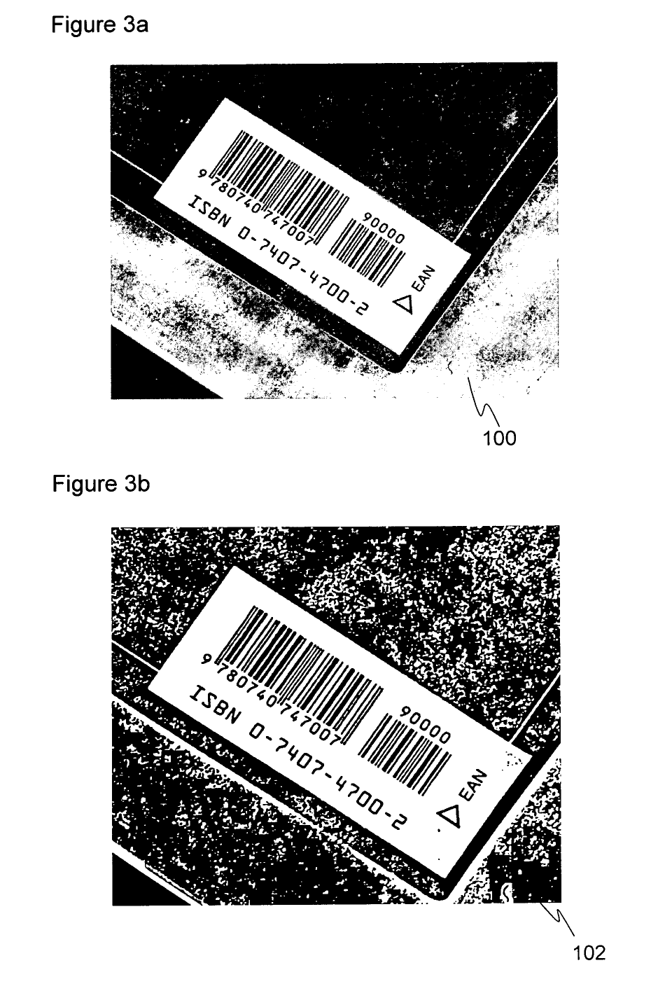

FIG. 3a an example of a gray value image of a code to be read, here a bar code;

FIG. 3b a black and white image created from the gray value image in accordance with FIG. 3a by binarization;

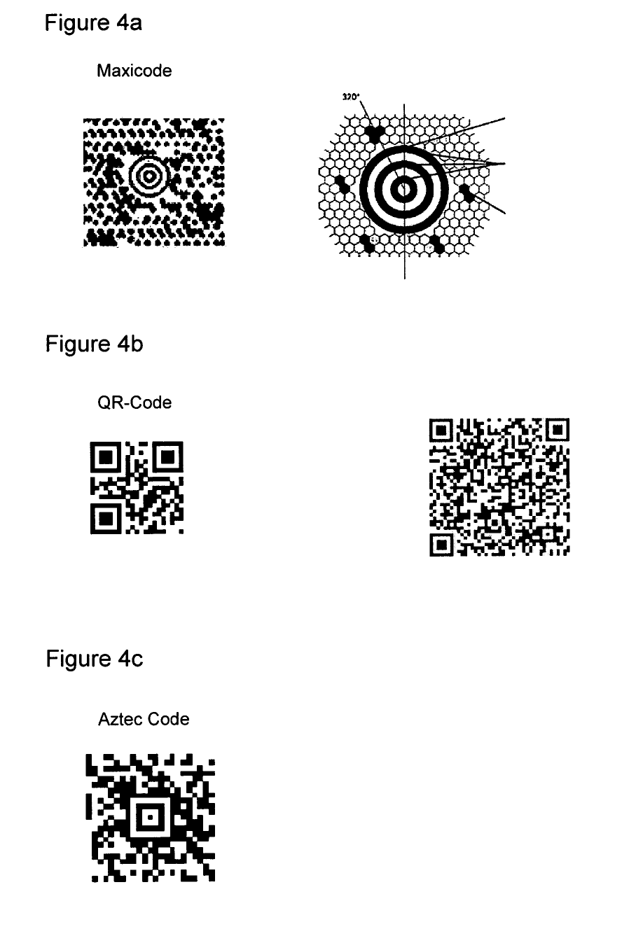

FIG. 4a the schematic representation of a maxicode as an example of a two-dimensional code for the explanation of the locating of code elements in a binary image;

FIG. 4b the schematic representation of a CR code as an example for a two-dimensional code;

FIG. 4c the schematic representation of an Aztec code as a further example for a two-dimensional code;

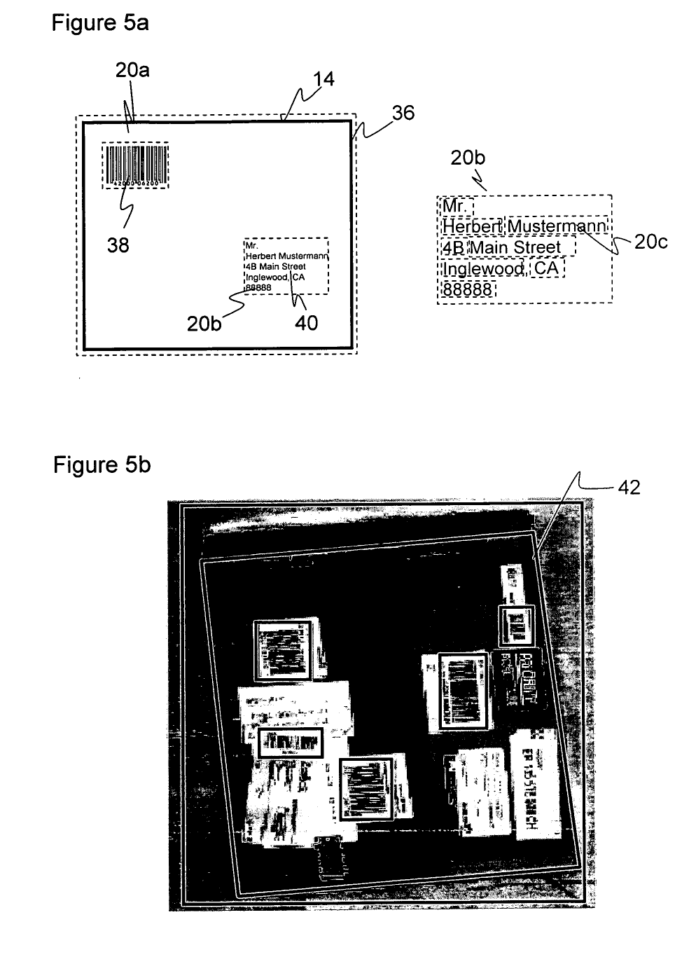

FIG. 5a the exemplary representation of a display of a structured file with a positional display of the regions of interest and of the decoding results; and

FIG. 5b the example of a gray value image of an object with the overlaid representation of the positional display of the regions of interest from the structured file.

FIG. 1 shows an optoelectronic sensor 10 in accordance with the invention which is mounted above a conveyor belt 12 which conveys objects 14 through the field of view 18 of the sensor 10, as indicated by the arrow 16. The objects 14 bear code regions 20 on their outer surfaces which are read and evaluated by the sensor 10. These code regions 20 can only be read by the sensor 10 when they are affixed to the upper side or at least in a manner recognizable from above. Contrary to the representation in FIG. 1, a plurality of sensors 10 can be installed from different directions for the reading of a code 21 affixed somewhat to the side or to the bottom in order to permit a so-called omnireading from all directions.

The field of view 18 of the sensor 10 is shown here as a single plane which corresponds to a line-shaped image sensor. This reading line can be realized by a scanner. In a preferred embodiment, the sensor 10 is, however, based on a camera chip, that is, for example, on a CCD or CMOS chip having a matrix-shaped or a line-shaped arrangement of light sensitive pixel elements. Since the objects 14 are taken or scanned line-wise in the conveying direction 16, a total image of the objects 18 conveyed past gradually arises. Alternatively to this line-wise scanning, however, other segments can also be taken. It is thus feasible, for example, to take larger regions from a plurality of lines simultaneously or, accepting the additional effort in the assembly of a total image, also any desired other geometry of the respective individual taken segments. The assembly to form a total image can be solved relatively easily in a stationary design with a uniform conveying of the objects 14, particularly when the conveying device 16 delivers path measurement data or speed measurement data. It is nevertheless feasible also to use the sensor 10 as a mobile unit, for example, a portable unit, and to lead it past the region to be read in each case.

It is the object of the sensor 10 to recognize the code regions 20 and to read out the codes affixed there, to decode them and to associate them with the respective associated object 14. The image processing required for this should now be explained in more detail with reference to a block diagram of the sensor 10 which is shown in FIG. 2. The sensor 10 and its components are provided in a common housing.

The light moves out of the visual range 18 via an optical camera system, which is not shown in FIG. 2 and which usually has a convergent lens and a protective front lens, to the image sensor 22 and there generates a pixel-resolved image of the segment then currently in the range of view 18. This segment will be called a line in the following; however, as mentioned above, without the invention being restricted thereto.

Each individual pixel adopts a color or a gray value. In this connection, any desired color depths are possible, but for most applications a color depth of 8 bits, which corresponds to 256 gray scales, is the best compromise between faster processing and sufficient color resolution or gray value resolution. In the further description, the color image and the gray value image will no longer be distinguished linguistically and they will both be called a gray value image.

In a further development of the invention, it is also possible additionally to determine the respective distance with reference to the light transit time in each pixel or with a taking element independent of the image sensor 22 in order to detect the object geometries and thus, for example, also to associate a volume with the objects. This is particularly useful for the planning of storage capacities and conveying capacities.

The raw image data of the image sensor 22 are transmitted to a filter 24 which is implemented on a programmable logic component such as an FPGA. This filter 24 processes the raw data by means of image processing methods known per se, for instance for noise suppression, contrast amplification, brightness correction or for the compensation of optical imaging errors, especially in the corner regions (flat field correction). A plurality of such filters 24 can also be implemented on the same programmable logic component or on a plurality thereof.

The raw data filtered in this manner are subsequently transmitted directly or via a common buffer to a binarizer 26 which is implemented together with the filter 24 on the same programmable logic component or on a separate programmable logic component. The operation of the filter 22 and of the binarizer 24 can alternatively also be processed with a different logic, for instance in ASIC, by means of a digital signal processor (DSP) or of a microprocessor.

The binarizer converts the filtered gray value image data into a binary image in which each pixel is only encoded by zero or one and a genuine black and white image without gray scales thus arises. This conversion is illustrated in FIG. 3 which shows an exemplary gray value image 100 of a bar code in FIG. 3a and the corresponding binary image 102 in FIG. 3b. The binary image can be stretched to increase the resolution.

There is always the risk in the binarization of losing major information by the reduction from eight bits to one bit of color depth. This can happen, for instance, with a fixed evaluation threshold which can then no longer distinguish between a poorly illuminated bright region and an illuminated dark region. For this reason, the binarizer 26 uses smart binarization algorithms which work with local, that is position dependently varying or floating, binarization thresholds. It is thus prevented that code information or other important image components are lost in the simplification from 265 gray scales to one black and white value.

The binarized image data are then applied to a PCI bus controlled by a PCI bus controller 28. The filter 24 in turn applies the filtered gray value data to the PCI bus. Both the gray value image and the binary image are therefore available there. The filter processing in the filter 24 and the binarization in the binarizer 26 take place in real time on the respective then currently delivered raw image data of the image sensor 22 and on its then currently taken line. The data of the next line are already running into the image sensor 22 while this image processing takes place. In this manner, a filtered gray value image and a binary image are already generated during the reception in real time and without any real time loss.

The already binarized image data are thus also available to an internal CPU 30 which is connected to the PCI bus almost simultaneously with the gray value image data.

A FIFO store with wrap-around 32 (container type queue “first in, first out”) is provided to store the respective then current image line and to discard the oldest image data if the FIFO store 32 has run full. After a start-up phase, a respective total image is thus available in the FIFO store 32 which consists of a plurality of last taken lines whose number corresponds to the size of the FIFO store 32. A wrap-around of this FIFO store 32 only means a cyclic arrangement in the sense that the first store cell in turn adjoins the last store cell, which is a particularly simple implementation of the FIFO principle.

Both the gray value data and the binary data are stored in the FIFO store 32 with the respective same relative address. It is thereby particularly simple to access corresponding gray values and binary values simultaneously.

Alternatively to a connection via the PCI bus, direct connections can also be provided between the binarizer and the internal CPU 30 and/or the FIFO store 32. Finally, it is also conceivable to connect the image sensor 22 directly to the FIFO store or via the PCI bus in order to store the read in lines there in each case which the filter 24 and the binarizer 26 then read out and further process, while new data run in via the image sensor 22 and are saved in the following storage cells of the FIFO store 32.

The internal CPU 30 has access via the PCI bus to the then currently filtered gray image line, the then current binarized line as well as all stored lines in the FIFO store 32. It can thus carry out image evaluations practically directly after reception of the image data based both on the gray image and on the binary image.

The internal CPU 30 locates objects and code regions in these image data in accordance with a method still to be explained, decodes the codes and translates them into clear text and transmits the decoder results to external and, depending on the configuration, also the gray value data and/or the binary data via an interface 34. This can be a wired or a wireless interface, depending on which of the typical interface factors such as bandwidth, disturbing wires, safety or costs is the most important. Gigabit Ethernet, serial, Bluetooth or WLAN are named in a non-exclusive manner.

It is also feasible to provide a further programmable logic component or to provide operations on an existing programmable logic component 24, 26 which convert the gray image and/or the binary image into a compressed format. The preferred format for the gray image is JPEG; the binary image can be converted into BMP, Fax G3 or Fax G4, for instance. Generally, this conversion can also take place in the internal CPU 30 whose computation power is, however, preferably relieved of such tasks In accordance with the invention to carry out the actual decoding.

In a highly corresponding manner, a thumbnail of the total image or of the binary image can also be generated on a logic component or in the internal CPU 30. This can in particular already take place before or simultaneously with the compression with the thumbnail also preferably already being generated in real time during the further reading in of data and, furthermore, in a compressed format such as the JPEG format.

The thumbnail can be transmitted to external by the sensor to enable a clear archiving of the read objects and codes without making high demands on storage and bandwidth. It is in particular time consuming with a compressed total image to prepare this thumbnail subsequently externally since, for this purpose, decompression must first be carried out, the thumbnail must be subsequently miniaturized and then compressed again.

A special application of the thumbnail results for parcel services which already offer querying the current location of the parcel over the internet from practically everywhere in accordance with the state of the art. Not only this location and the time, but also a photograph of the expected or dispatched parcel can be accessed and displayed by means of the thumbnail.

In a special embodiment of the invention, the sensor is only designed to generate the total image and the thumbnail and to output it to external, that is it cannot generate any binary image.

A loss-free compression of the binary data such as a run length encoding in which sequences of equivalent bits are encoded numerically by the number is allowed, for example, by the BMP format. A run-length encoded binary image not only has less storage requirements, but also enables a faster search for relevant code regions 22 as will be explained in the following. The Fax G4 format has the advantage that a container is provided in which the JPEG image data and the binary image data can be accommodated together.

The internal CPU 30 can output any desired combination of gray value image, binary image and thumbnail in one of the named graphic formats or in a further graphic format via the interface 34. A particularly elegant method is to encode the binary image into the gray image in that in each case the meaning of the binary image is given to a bit of the gray value data with respect to a pixel. If the least significant bit is used for this purpose, the gray value is thereby hardly noticeably changed.

The image processing in the internal CPU 30 takes place in two stages. Regions of interest (ROI) are first identified. They can be characterized by reflection properties, specific shapes, colors or the like. A region of interest can be an object 14 or a part of an object 14 such as a code region 20 or a text region, in particular on a sticker identifiable with reference to its optical properties.

The precise position of the code for the decoding or the precise position of the text for an OCR recognition within these regions of interest have to be determined by the internal CPU 30. The FIGS. 4a-c show some examples of a two-dimensional code. The invention can also be used for one-dimensional codes, that is substantially bar codes.

The two-dimensional codes provide respective special characteristic standard patterns for the adjustment. With the maxicode in accordance with FIG. 4a, this is a type of target of concentric black and white circles. The QR (quick response) code in accordance with FIG. 4b provides for a plurality of nesting black and white squares; the Aztec code in accordance with FIG. 4c only one such standard pattern. As illustrated in the right hand part of FIG. 4a, the reference position illustrated by a perpendicular line can be recognized with reference to a specific signature: in each case a specific number of black, white, black, etc. pixels have to form a sequence, otherwise this line is not a diameter. Similar characteristic signatures can also be defined for other two-dimensional codes.

This search for characteristic search patterns also functions in the run length encoded binary image; in particular search patterns independent of the rotary position can be quickly identified by the search for characteristic run length patterns.

If a two-dimensional code has once been localized in this manner, it can also be decoded quickly in the binary image and/or in the correspondingly stored gray value image. This is easier for a one-dimensional code; each line through a bar code, which intersects it in full longitudinal direction, traverses the full information.

The internal CPU 30 stores the positions of the regions of interest. This is illustrated in FIG. 5a. A dashed rectangle 36 characterizes the region of interest of an object 14. The region of interest 20a of a bar code 38 and the region of interest 20b of a text 40 are marked correspondingly by dashed lines. The region of interest 20b around the text 40 is shown enlarged again on the right hand side. It can be recognized that every single word also forms a region of interest 20c and the internal CPU 30 has recognized the position of each word. In an alternative embodiment, text does not count as one of the regions of interest and its recognition remains reserved to downstream external image evaluation. For the OCR algorithms used are not only very complex, they above all access address databases for the comparison and for the supplementation of the decoded information, said address databases having large storage requirements and having to be updated regularly. It is therefore possible to carry out this storage-intensive and computation-intensive OCR evaluation in the sensor; however, embodiments are also feasible in which only the text regions are recognized by the sensor without evaluating them or in which any evaluation in connection with text recognition only takes place externally.

A representation like that of FIG. 5a can be generated from the positions of the regions of interest and the gray value data or binary data, in which the regions of interest are made recognizable by dashed rectangles, which are rather colored rectangles in practice, or by other graphic emphasis. FIG. 5b shows such a gray image value of a parcel as an object 14 with such regions of interest marked by rectangles.

It is often not desired to transmit the image data in their totality for external further processing of image data in any form. Instead of this, it would be sufficient to trim the images to specific regions of interest (“cropping”) and only to store and transmit image data within these regions of interest. For this purpose, generally those image data can be deleted which are outside the desired limits or the reading region is set accordingly from the start, for example to the width of the conveyor belt.

However, this does not work with real time compression, for instance into JEPG format, because it is not even known yet in the data then currently being processed whether they are inside or outside the region to be cropped. In contrast, the position of the object, which usually defines the cropping limits, is known after it has been passed over completely and the sensor can determine all the cropping data at this time. Instead of now physically trimming the image by deleting data outside the cropping limits, for which purpose the JPEG compression would first have to be reversed and recompressed after the cropping, the position of the object and thus the position of the cropping limits are added to the structured file. A later external application can now in turn effect a real cropping or at least knows the limits outside of which it no longer needs to look for relevant information.

In most cases, a few corner points are already sufficient for the determination of the cropping limits, provided the assumption of parallelepiped shaped objects is justified. In FIG. 5b, such a cropping limit 42 is shown by way of example which is described completely and with very few data solely by the corner points of the rectangle.

In a further embodiment, the sensor 10 itself, or a further sensor connected beforehand, via CAN bus for instance, is able to determine the geometrical contour of the objects 14. A possible method is scanning using a laser scanner while determining the light transit time. Positional and contour data, that is, for instance, the height, length and width of an object as well as the volume of the object or of an enveloping parallelepiped can be determined from this and added to the structured file. If, finally, a plurality of codes are located on an object, the object height for each code can be determined and added to the structured file. Since text regions are usually also located in the vicinity of the codes and are relevant to an external OCR recognition, the code positions and code heights serve as reference positions or starting points for the text search and the scale factor is already known from the structured file.

The internal CPU 30 assembles a structured file from the components described, namely the gray value image, the binary image, the thumbnail, any conversions of the same into a known graphic format such as JPEG, BMP, Fax G4, the positions of the region of interest and the decoding results or texts recognized by OCR, individually or in any desired combination. One combination to be emphasized is an overlay without the image data which therefore only includes positions of regions of interest and associated decoding results/text. In accordance with the invention, XML is provided as the format for this structured file, but corresponding structured and encompassing formats can equally be used.

This structured file therefore contains not only the graphics and the contents of the codes, but also, as an overlay, the positions of the regions of interest which can be displayed for diagnostic purposes or for other purposes after reception via the external interface 34. If an image such as that of FIG. 5b is displayed together with the decoded contents of the code regions, a user can recognize at a glance whether the image evaluation was correct. Optionally, a correcting intervention can be made. The structured field can also be used to carry out further image processing externally, optionally with more complex image evaluation algorithms which put too much strain on the computing power of the internal CPU 30. Finally, the structured file can be stored to understand reading errors at a later date and to avoid them in future. Structured files in which such reading errors have been found can, optionally, also be transmitted to a more powerful external image processing which does not make these recognition errors. This external image processing could also automatically recognize randomly when the sensor has incorrectly evaluated an image. In this manner, particularly difficult situations can be treated more extensively and thus the error rate can be further reduced in two stages.

The display of a structured file in XML format takes place via any desired XML viewer which translates and displays the graphic primitives into rectangles, text contents, graphic presentations or the like. Some instructions or graphic XML primitives should be named by way of example:

DOT—Draw a dot

CROSS—Draw a cross

LINE—Draw a line between two dots

BOX—Draw a polygon with four corner points

TEXT—Draw a string

The structured file of an overlay assembled for the graphic primitives can have the following appearance, for example:

<?xml version=″1.0″?>
<camera name=″Cam#1″ company=″SICK AG″ device=″OurSensor″ >
<image objectid=″4″
<QualityJpeg>75</ QualityJpeg>
<ScaleBmp>4</ScaleBmp>

<symbol type=″ITL25″ pos=″3657 1321 3642 1144 3342 1171 3357
1349″>
<result length=″14″ coding=″Ascii > 21385000021007</ result>
</symbol>

</image>
</camera>

An association between a recognized object and the code located thereon can also be exported beyond the named elements of the structured file, or texts within the XML file or in another manner, for instance as a separate file. All the relevant information is thus available at the sensor interface 34: all the information on the object which can also contain object contours and volumes calculated therefrom when a distance-resolving image sensor is used as well as all the code information and text information belonging to the object as well as a displayable XML file with which the obtaining of this information can be reconstructed, improved as required or checked for diagnostic purposes.

1. An optoelectronic sensor (10) for the detection of codes having a light receiver (22) which is designed for reading in segments of color image data or gray value image data as well as having an evaluation unit (30) which can assemble the image data to form a total image (100), with a binarizer (26) of the sensor (10) additionally being provided to generate a binary image (102) from the color image data or gray value image data, characterized in that the binarizer (26) is designed for a conversion into the binary image (102) during the reception and/or in real time in that the color image data or gray value image data of each read in segment are binarized while the further segments are still being read in.

2. A sensor (10) in accordance with claim 1, characterized in that the evaluation unit (30) is designed to generate a structured file which includes the decoding results (38, 40) and/or overlay data with positions of regions of interest (20a, 20b, 20c, 36) of recognized objects (14) or regions with codes or text (20, 38, 40).

3. An optoelectronic sensor (10) for the detection of codes having a light receiver (22) which is designed for a reading in of color image data or gray value data as well as having an evaluation unit (30) which can assemble the image data to form a total image (100), characterized in that the evaluation unit (30) is designed to generate a structured file which includes decoding results (38, 40) and/or overlay data with positions of regions of interest (20a, 20b, 20c, 36) of recognized objects (14) or regions with codes or text (20, 38, 40).

4. A sensor (10) in accordance with claim 3, characterized in that the light receiver (22) is designed for reading in segments of the color image data or gray value image data and in that a binarizer (26) of the sensor (10) is additionally provided to generate a binary image (102) from the color image data or the gray value image data, and wherein in particular the binarizer (26) is designed for a conversion into the binary image (102) during the reception and/or in real time in that the color image data or gray value image data of each read in segment are binarized while the further segments are still being read in.

5. A sensor (10) in accordance with claim 1, characterized in that the evaluation unit (30) is designed to output the total image (100), the binary image (102) and/or a thumbnail, in particular as a component of the structured file.

6. A sensor (10) in accordance with claim 2, characterized in that the evaluation unit (30) is designed to provide the structured file with cropping information which marks the position of objects in the image data (100, 102), in particular with reference to positions of the corner points.

7. A sensor (10) in accordance with claim 2, characterized in that the evaluation unit (30) is designed to provide the structured file with graphic instructions which visually mark the regions of interest (20a, 20b, 20c, 36) on display of the structured file in an external display device, in particular by colored rectangles, and/or display the decoding results in text form.

8. A sensor (10) in accordance with claim 2, characterized in that the evaluation unit (30) is designed to provide the structured file with information which make a connection between recognized objects (14), codes (38, 40) and/or decoding results (38, 40).

9. A sensor (10) in accordance with claim 2, characterized in that the evaluation unit (30) is designed to provide the structured file with information which describes the length, width, height and the maximum box volume of recognized objects and/or three-dimensional positions, in particular heights, of the recognized objects (14) underlying regions of interest and/or regions with codes or texts (20, 38, 40).

10. A sensor (10) in accordance with claim 1 which is a camera based code reader, in particular with a line scan camera, and/or is mounted in a stationary manner at a conveyor (12).

11. A sensor (10) in accordance with claim 1, characterized in that the binarizer (26) is designed for a binarization with floating and/or local binarization thresholds.

12. A sensor (10) in accordance with claim 1, characterized in that the light receiver (22) and the binarizer (26) are designed to transmit the color image data or gray value image data of each segment to the evaluation unit (30) substantially simultaneously with the binarized image date or to buffer them, in particular with the same relative addresses.

13. A sensor (10) in accordance with claim 1, characterized in that the light receiver (22) is connected via at least one programmable logic component (24, 26) to the evaluation unit, in particular by PCI bus, and the binarizer (26) and/or an image processing filter (24) is/are implemented on the programmable logic component.

14. A sensor (10) in accordance with claim 1, characterized in that the evaluation unit (30) is integrated into a common housing with the sensor components and an interface (34) is provided to transmit image data of the total image (100) and of the binary image (102) to external, in particular a wired serial or Ethernet interface or a wireless Bluetooth or WLAN interface.

15. A sensor (10) in accordance with claim 1, characterized in that the binarizer (26) and/or the evaluation unit (30) is designed to compress the binary image (102) in a loss-free manner or it encode it into the total image.

16. A sensor (10) in accordance with claim 1, characterized in that the evaluation unit (30) is designed to locate codes in the binary image (102) with reference to characteristic search patterns, that is signatures, which characterize a code as such with respect to other picture elements.

17. A sensor (10) in accordance with claim 3, characterized in that the evaluation unit (30) is designed to output the total image (100), the binary image (102) and/or a thumbnail, in particular as a component of the structured file.

18. A sensor (10) in accordance with claim 3, characterized in that the evaluation unit (30) is designed to provide the structured file with cropping information which marks the position of objects in the image data (100, 102), in particular with reference to positions of the corner points.

19. A sensor (10) in accordance with claim 3, characterized in that the evaluation unit (30) is designed to provide the structured file with graphic instructions which visually mark the regions of interest (20a, 20b, 20c, 36) on display of the structured file in an external display device, in particular by colored rectangles, and/or display the decoding results in text form.

20. A sensor (10) in accordance with claim 3, characterized in that the evaluation unit (30) is designed to provide the structured file with information which make a connection between recognized objects (14), codes (38, 40) and/or decoding results (38, 40).

21. A sensor (10) in accordance with claim 3, characterized in that the evaluation unit (30) is designed to provide the structured file with information which describes the length, width, height and the maximum box volume of recognized objects and/or three-dimensional positions, in particular heights, of the recognized objects (14) underlying regions of interest and/or regions with codes or texts (20, 38, 40).

22. A sensor (10) in accordance with claim 3 which is a camera based code reader, in particular with a line scan camera, and/or is mounted in a stationary manner at a conveyor (12).

23. A sensor (10) in accordance with claim 3, characterized in that the binarizer (26) is designed for a binarization with floating and/or local binarization thresholds.

24. A sensor (10) in accordance with claim 3, characterized in that the light receiver (22) and the binarizer (26) are designed to transmit the color image data or gray value image data of each segment to the evaluation unit (30) substantially simultaneously with the binarized image date or to buffer them, in particular with the same relative addresses.

25. A sensor (10) in accordance with claim 3, characterized in that the light receiver (22) is connected via at least one programmable logic component (24, 26) to the evaluation unit, in particular by PCI bus, and the binarizer (26) and/or an image processing filter (24) is/are implemented on the programmable logic component.

26. A sensor (10) in accordance with claim 3, characterized in that the evaluation unit (30) is integrated into a common housing with the sensor components and an interface (34) is provided to transmit image data of the total image (100) and of the binary image (102) to external, in particular a wired serial or Ethernet interface or a wireless Bluetooth or WLAN interface.

27. A sensor (10) in accordance with claim 3, characterized in that the binarizer (26) and/or the evaluation unit (30) is designed to compress the binary image (102) in a loss-free manner or it encode it into the total image.

28. A sensor (10) in accordance with claim 3, characterized in that the evaluation unit (30) is designed to locate codes in the binary image (102) with reference to characteristic search patterns, that is signatures, which characterize a code as such with respect to other picture elements.

29. A method for the detection of codes by means of an optoelectronic sensor (10), wherein color image data or gray value image data are read in segment-wise and are assembled to form a total image (100), and wherein a binary image (102) is generated from the color image data or gray value image data, characterized in that a conversion into the binary image (102) is already carried out during the reception and/or in real time in that the color image data or gray value image data of each read in segment are binarized while the further segments are still being read in.

30. A method in accordance with claim 29, characterized in that a structured file is generated in the sensor (10) for output to an external controller of an external display device and includes overlay data with decoding results and/or with positions of regions of interest (20a, 20b, 20c, 36) of recognized objects or regions with codes or text (20, 38, 40).

31. A method for the detection of codes by means of an optoelectronic sensor (10), wherein color image data or gray value image data are read in segment-wise, in particular line-wise, and are assembled to form a total image (100), characterized in that a structured file is generated which includes decoding results (38, 40) and/or overlay data with positions of regions of interest (20a, 20b, 20c, 36) of recognized objects (14) or regions with codes or text (20, 38, 40).

32. A method in accordance with claim 31, characterized in that a binary image (102) is generated from the color image data or gray value image data and the conversion into the binary image (102) is already carried out during the reception and/or in real time in that the color image data or gray value image data of each read in segment are binarized while the further segments are still being read in.

33. A method in accordance with claim 30, characterized in that the total image (100), the binary image (102) and/or a thumbnail are output, in particular as a component of the structured file.

34. A method in accordance with claim 30, characterized in that the structured file is provided with cropping information which marks the position of objects in the image data (100, 102), in particular with reference to positions of the corner points.

35. A method in accordance with claim 30, characterized in that the structured file is provided with graphic instructions which visually mark the regions of interest (20a, 20b, 20c, 36) on display of the structured file, in particular by colored rectangles, and/or display the decoding results in text form.

36. A method in accordance with claim 30, characterized in that the structured file is provided with information which makes a connection between recognized objects (14), codes (38, 40) and/or decoding results (38, 40).

37. A method in accordance with claim 30, characterized in that the structured file is provided with information which describes the length, width, height and the maximum box volume of recognized objects and/or three-dimensional positions, in particular heights, of the recognized objects (14) underlying regions of interest and/or regions with codes or texts (40, 38, 40).

38. A method in accordance with claim 29, characterized in that the sensor (10) is a camera-based code reader, in particular with a line-scan camera which is mounted in stationary form to a conveyor (12).

39. A method in accordance with claim 31, characterized in that the total image (100), the binary image (102) and/or a thumbnail are output, in particular as a component of the structured file.

40. A method in accordance with claim 31, characterized in that the structured file is provided with cropping information which marks the position of objects in the image data (100, 102), in particular with reference to positions of the corner points.

41. A method in accordance with claim 31, characterized in that the structured file is provided with graphic instructions which visually mark the regions of interest (20a, 20b, 20c, 36) on display of the structured file, in particular by colored rectangles, and/or display the decoding results in text form.

42. A method in accordance with claim 31, characterized in that the structured file is provided with information which makes a connection between recognized objects (14), codes (38, 40) and/or decoding results (38, 40).

43. A method in accordance with claim 31, characterized in that the structured file is provided with information which describes the length, width, height and the maximum box volume of recognized objects and/or three-dimensional positions, in particular heights, of the recognized objects (14) underlying regions of interest and/or regions with codes or texts (40, 38, 40).

44. A method in accordance with claim 31, characterized in that the sensor (10) is a camera-based code reader, in particular with a line-scan camera which is mounted in stationary form to a conveyor (12).
